(19) United States
(12) Patent Application Publication
(10) Pub. No.: US 2025/0030166 A1
(43) Pub. Date: Jan. 23, 2025

(54) ADDITIVELY MANUFACTURED PROBE FED PATCH ANTENNA

(71) Applicant: BAE SYSTEMS Information and Electronic Systems Integration Inc., Nashua, NH (US)

(72) Inventors: Jean L. Kubwimana, Merrimack, NH (US); Alexander D. Johnson, Waltham, MA (US); Arturs E. Dinbergs, Hollis, NH (US); Jacob Tamasy, Nashua, NH (US); James F. Fung, Manchester, NH (US)

(73) Assignee: BAE SYSTEMS Information and Electronic Systems Integration Inc., Nashua, NH (US)

(21) Appl. No.: 18/222,658

(22) Filed: Jul. 17, 2023

(51) Int. Cl. H01Q 9/04; H01Q 1/22; H01Q 1/36

(52) U.S. Cl. CPC H01Q 9/0407; H01Q 1/2283; H01Q 1/364

(57) ABSTRACT

A method of manufacturing an antenna assembly includes additively manufacturing an element that is monolithic and that includes (i) a ground plane, (ii) a patch above the ground plane, and (iii) a structure having a lower end in contact with the ground plane and an upper end in contact with the patch. The method further includes applying a dielectric material between the ground plane and the patch. In an example, the dielectric material is dielectric foam. The method further includes removing a section of the ground plane around the lower end of the structure, such that the structure extends through the ground plane and not in contact with the ground plane. The method further includes connecting an inner conductor of a coaxial cable connector to the lower end of the structure, and an outer portion of the coaxial cable connector to the ground plane.

### FIELD OF DISCLOSURE

The present disclosure relates to antennas, and more particularly, to patch antenna structures.

### BACKGROUND

A patch antenna is a type of antenna with a low profile, which can be mounted on a surface. It includes a sheet or “patch” of metal, mounted over a larger sheet of metal called a ground plane. The metal sheets (the ground plane and the patch of metal) together form a transmission line with a length of approximately one-half wavelength of the radio waves. The radiation mechanism arises from fringing fields along the radiating edges. A patch antenna is often used at microwave frequencies, at which wavelengths are short enough that the patches are relatively small. There remain a number of non-trivial challenges with respect to designing and manufacturing patch antenna structures.

### BRIEF DESCRIPTION OF THE DRAWINGS

FIGS. 1A, 1B, and 1C illustrate various views of an antenna structure, wherein the antenna structure comprises (i) a ground plane comprising conductive material, (ii) a patch above the ground plane, (iii) a dielectric material between the ground plane and the patch, and (iv) a probe extending through an opening within the ground plane and through the dielectric material, the probe between a coaxial connector and the patch, in accordance with an embodiment of the present disclosure.

FIGS. 1B1 and 1C1 illustrate various views of an antenna structure that is at least in part similar to the antenna structure of FIGS. 1A-1C, and wherein the antenna structure of FIGS. 1B1 and 1C1 includes (i) a first section and a second section of the patch having an interface (such as a seam) therebetween, in accordance with an embodiment of the present disclosure.

FIGS. 1B2 and 1C2 illustrate various views of an antenna structure that is at least in part similar to the antenna structure of FIGS. 1A-1C, and wherein the antenna structure of FIGS. 1B1 and 1C1 includes the patch having two openings that are filled with dielectric material, in accordance with an embodiment of the present disclosure.

FIG. 2 illustrates a cross-sectional view of an antenna structure that is at least in part similar to the antenna structure of FIGS. 1A-1C2, wherein the antenna structure of FIG. 2 includes a vertical stack of at least two patches, in accordance with an embodiment of the present disclosure.

FIG. 3 illustrates a cross-sectional view of an antenna structure that is at least in part similar to the antenna structure of FIG. 2, wherein the antenna structure of FIG. 3 includes a first probe and a second probe, in accordance with an embodiment of the present disclosure.

FIG. 4 illustrates a cross-sectional view of an antenna structure that is at least in part similar to the antenna structure of FIGS. 1A-1C2, wherein the antenna structure of FIG. 4 includes a shorting structure that electrically shorts the patch and the ground plane, in accordance with an embodiment of the present disclosure.

FIG. 5 illustrates a perspective view of an antenna array comprising a plurality of antenna structures of any of FIGS. 1A-4, in accordance with an embodiment of the present disclosure.

FIG. 6 illustrates a flowchart depicting a method of forming the example antenna structures of FIGS. 1A-5 using, in accordance with an embodiment of the present disclosure.

FIGS. 7A1, 7A2, 7B1, 7B2, 7C1, 7C2, 7D1, 7D2, 7E1, and 7E2 collectively illustrate an example antenna structure in various stages of processing in accordance with the methodology of FIG. 6, in accordance with an embodiment of the present disclosure.

FIG. 8 illustrates a flowchart depicting another method of forming the example antenna structures of FIGS. 1A-5, in accordance with an embodiment of the present disclosure.

FIGS. 9A, 9B, 9C, 9D1, 9D2, and 9E collectively illustrate an example antenna structure in various stages of processing in accordance with the methodology of FIG. 8, in accordance with an embodiment of the present disclosure.

Although the following detailed description will proceed with reference being made to illustrative examples, many alternatives, modifications, and variations thereof will be apparent in light of this disclosure.

### DETAILED DESCRIPTION

Antenna assemblies are disclosed. An example assembly includes a probe fed radiating patch above a ground plane, where the patch is separated from the ground plane by a layer of dielectric material (e.g., a dielectric foam material). A probe extends from a surface of the patch, through an opening within the dielectric material, and extends further through an opening within the ground plane. In an example, the opening within the ground plane is large enough, such that the probe extending through the ground plane is electrically and physically isolated from the ground plane. A coaxial cable connector can be connected to the probe. In an example, several such antenna structures may be laterally arranged in an array, to thereby form an antenna array.

In some examples, the antenna structure may be at least in part manufactured using an additively manufacturing process, such as using one or more three dimensional (3D) printers. In one embodiment, a method of manufacturing the antenna structure comprises additively manufacturing an element that is a continuous and monolithic structure comprising conductive material and that includes (i) a ground plane, (ii) a patch above the ground plane, and (iii) a structure having a lower end in contact with the ground plane and an upper end in contact with the patch. The method further includes applying a dielectric material between the ground plane and the patch. In an example, the dielectric material is a dielectric foam material. The method further includes removing at least a section of the ground plane around the lower end of the structure, such that the structure extends through the ground plane and is not in contact with the ground plane.

In another embodiment, a method of manufacturing the antenna structure comprises forming a ground plane comprising conductive material, and forming a layer of dielectric material above the ground plane. In an example, the ground plane has a first opening extending through the ground plane, and the layer of dielectric material has a second opening extending through the layer of dielectric material, such that the first opening is below and at least in part aligned with the second opening. In some examples, the ground plane may be additively manufactured, with the first opening therewithin, and the second opening within the layer of dielectric material may be formed using a subtractive material removal process. In some other examples, once the layer of dielectric material is formed, both the first and second openings may be formed using a subtractive material removal process. The method further includes placing a patch on the layer of dielectric material, the patch having a probe on a lower surface of the patch. The probe extends within the first and second openings, when the patch is placed on the layer of dielectric material. Numerous configurations and variations will be apparent in light of this disclosure.

### General Overview

As mentioned herein above, there remain a number of non-trivial challenges with respect to designing and manufacturing patch antenna assemblies. For example, printed circuit board (PCB) material may be used as a dielectric material between a ground plane and a patch. However, redesigning a PCB (e.g., to change its dimensions), e.g., to tune parameters of the patch antenna, may be time consuming and/or expensive, and may not be done on the fly, and such PCB material may not be relatively easily scalable with frequency and bandwidth.

Accordingly, techniques are described herein to form an antenna structure using additive manufacturing processes, where the antenna structure comprises a probe fed patch above a ground plane, and separated from the ground plane by a dielectric material, such as a dielectric foam material. Additive manufacturing, such as 3D printing, may use computer-aided-design (CAD) software and/or 3D object scanners to direct hardware to deposit material, layer upon layer, in precise geometric shapes. As its name implies, additive manufacturing adds material to create an object. Thus, additive manufacturing involves a computer-controlled process that creates 3D objects by depositing materials, usually in layers. In an example, the antenna design can be easily altered and tuned to achieve frequency scalability, e.g., by modifying the 3D printing process (such as by changing the software codes for the 3D printing process). This may be relatively easy, compared to redesigning a PCB for example. Furthermore, application of a foam based dielectric material within the antenna structure described herein may also be altered relatively easily, e.g., to tune the antenna parameters. Accordingly, manufacturing processes described herein are highly flexible, and frequency scaling can be achieved relatively easily, in an example.

In an example, the antenna structure comprises a ground plane including conductive material, such as one or more metals and/or alloys thereof. A radiating patch above the ground plane similarly comprises conductive material, such as one or more metals and/or alloys thereof. A layer of dielectric material is between the patch and the ground plane, where the dielectric material is dielectric foam material formed using an appropriate foaming process.

In one embodiment, a conductive probe extends from a lower surface of the patch, through an opening within the dielectric material, and extends further through an opening within the ground plane. In an example, the opening within the ground plane is large enough, such that the probe extending through the ground plane is electrically and physically isolated from the ground plane. For example, a diameter of the opening within the ground plane may be at least as large as, or greater than, a diameter of the opening within the dielectric material. As described below in further detail, the opening within the ground plane has to be large enough such that the probe extending through the opening doesn't touch the sidewalls of the opening, and a minimum threshold gap is maintained between sidewalls of the opening of the ground plane and the probe, e.g., to avoid or at least reduce chances of electrical arcing and/or electrical shorting between the probe and the ground plane. In contrast, there may not be a need to maintain such a gap between the probe and the dielectric material, e.g., when the probe extends through the opening within the dielectric material.

In one embodiment, a coaxial cable connector is connected to an end of the probe. The connector comprises an inner conductor surrounded by a concentric outer conducting shield. In an example, the inner conductor is electrically coupled to (e.g., in direct or indirect physical contact with) a lower end of the probe, and the outer conducting shield is electrically coupled to (e.g., in direct or indirect physical contact with) the ground plane. In an example, the inner conductor is separate, and electrically isolated from the outer conducting shield by a dielectric material of the coaxial cable connector. In an example, the outer conducting shield of the connected is electrically grounded, e.g., thereby electrically grounding the ground plane. The inner conductor receives an electrical signal, which is transmitted to the patch, e.g., via the probe. Thus, the probe acts as a feed line to the patch. The patch radiates microwave signals (hence, the patch is also referred to herein as a radiating patch), due to fringing fields along the radiating edges of the antenna structure.

Thus, the example antenna structure comprises the patch, the probe, the ground plane, and the dielectric material between the patch and the ground plane. In some cases, several such antenna structures may be laterally arranged in an array, to thereby form an antenna array (e.g., see FIG. 5). In the antenna array, each of the ground plane and the layer of dielectric material may be common to the multiple antenna structures. Furthermore, each antenna structure includes a corresponding patch and a corresponding probe. For example, the antenna array comprises a laterally adjacent array of patches and corresponding probes, e.g., see FIG. 5.

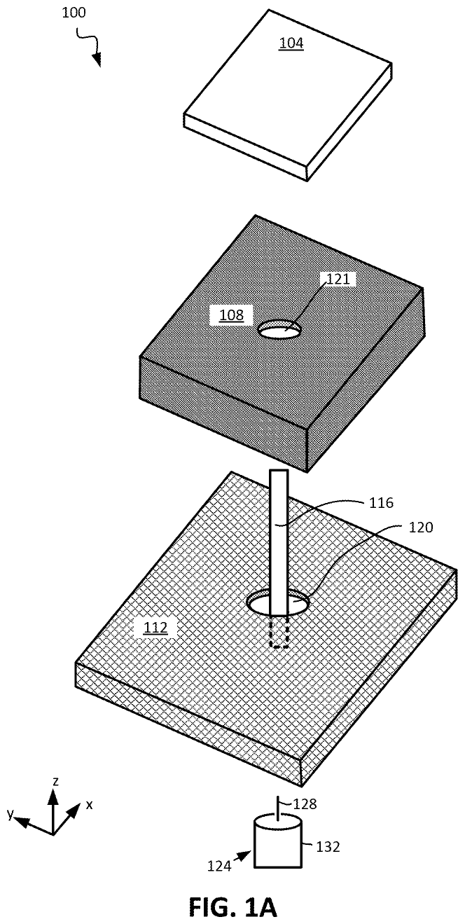

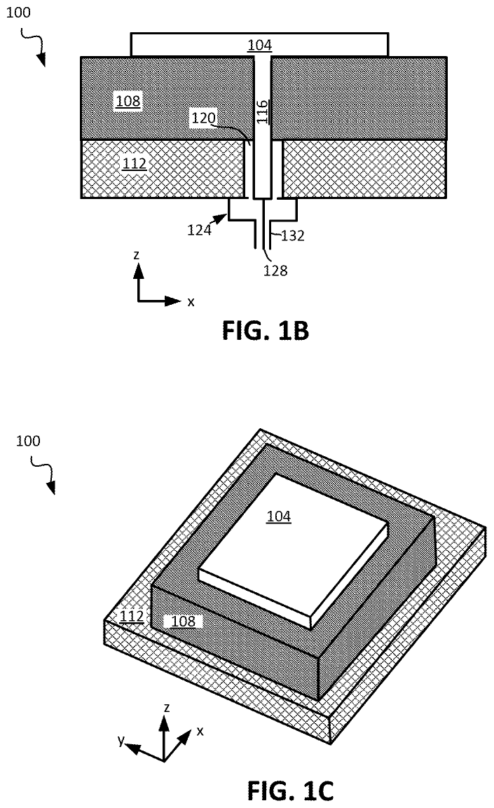

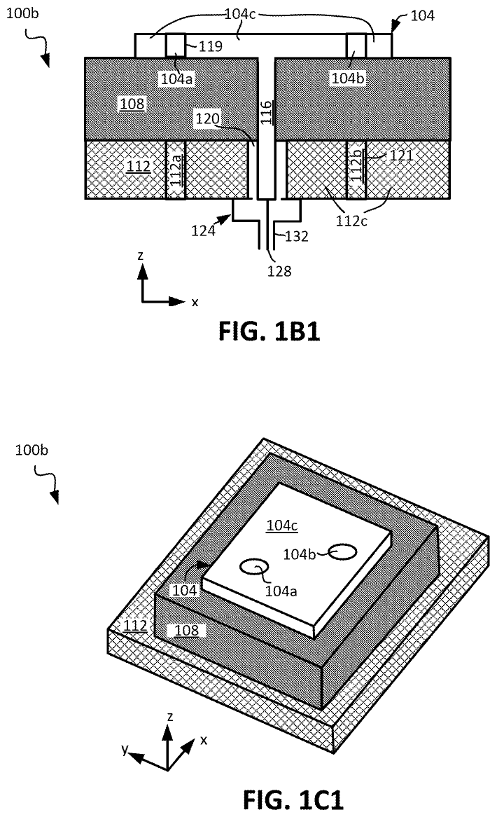

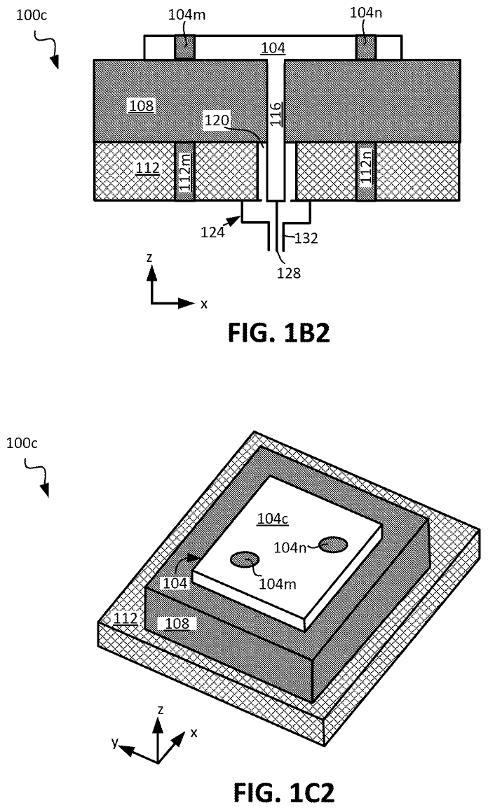

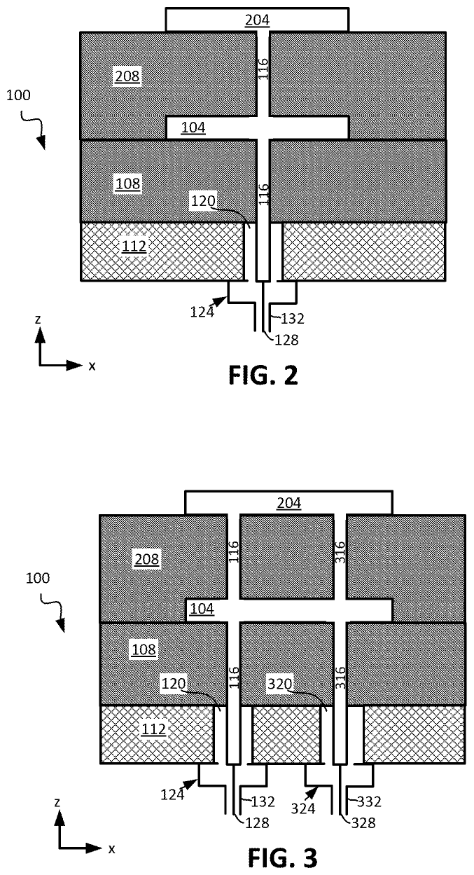

In some examples, each antenna structure includes a single corresponding patch, e.g., see FIGS. 1A-1C2, 4 and 5. However, each antenna structure may include more than one patch, such as a vertical stack of two or more patches, e.g., see FIGS. 2 and 3.

Furthermore, in some examples, a single probe corresponding to a single polarization (e.g., a vertical polarization or a horizontal polarization) may be included in an antenna structure. However, in some other examples, there may be more than one probe, such as two probes corresponding to two polarizations, e.g., a vertical polarization and a horizontal polarization, such as the antenna structure illustrated in FIG. 3.

The antenna structure can be manufactured using a variety of approaches, but in some example cases, the antenna structure is manufactured using additive manufacturing processes, such as a 3D printing process. One example of printing conductive materials such as metals is by employing direct metal laser melting (DMLM). A number of approaches are described below to manufacture antenna structures.

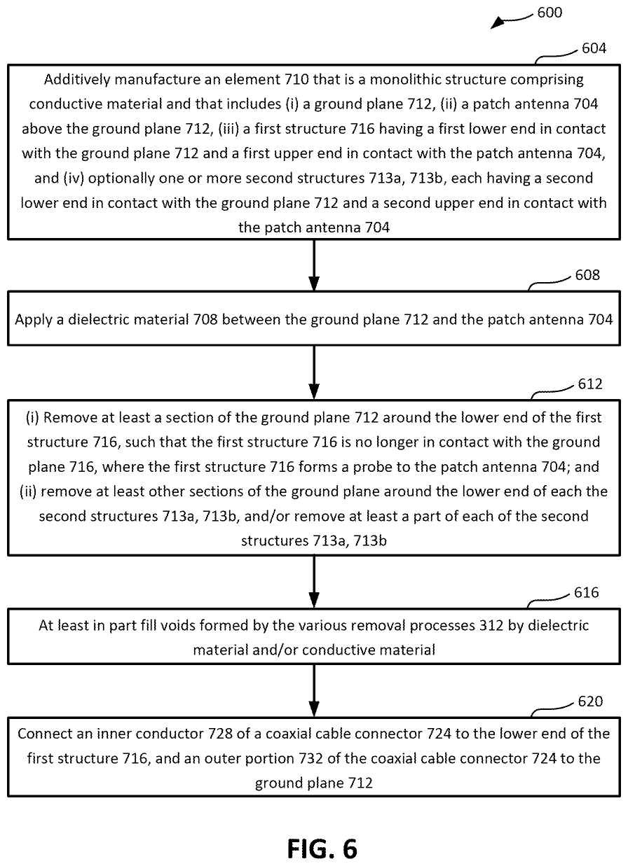

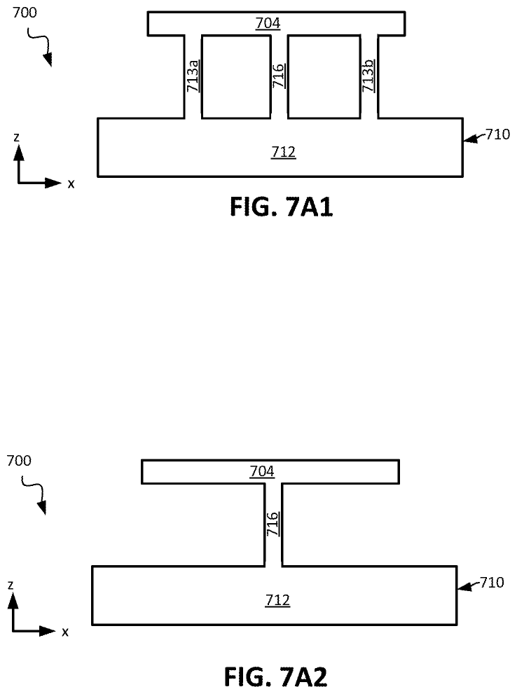

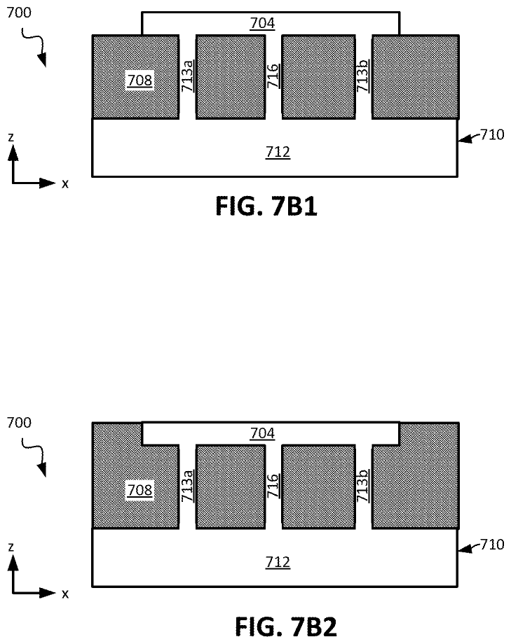

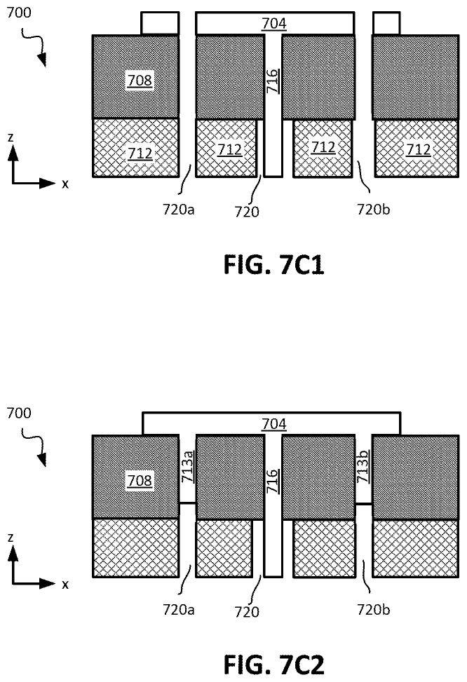

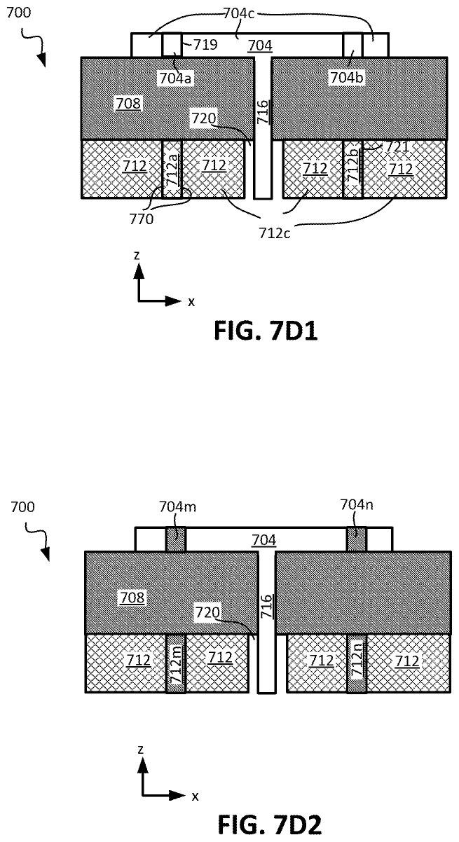

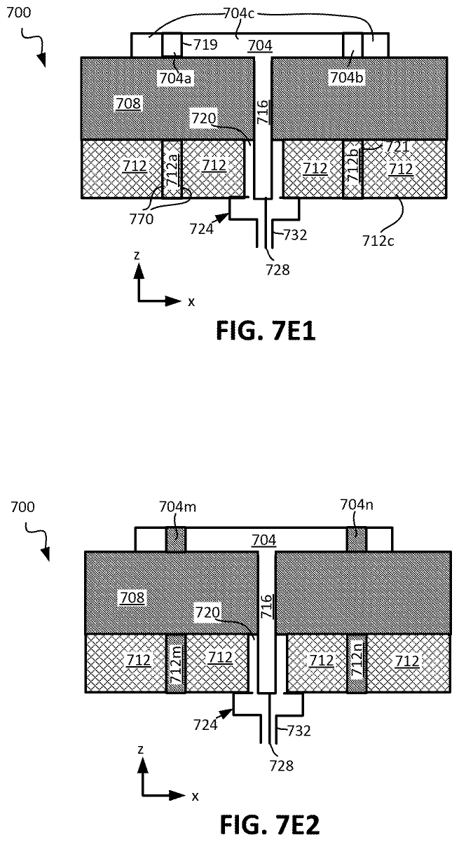

In one approach (e.g., described with respect to FIGS. 6-7E2), an element may be manufactured additively, e.g., using a 3D printing process. The element (e.g., element 710 of FIGS. 7A1, 7A2) may be a continuous and monolithic structure comprising conductive material and that includes (i) a ground plane, (ii) a patch above the ground plane, (iii) a first structure having a lower end coupled to (e.g., in contact with) the ground plane and an upper end coupled to (e.g., in contact with) the patch, and (iv) optionally one or more second structures each having a lower end coupled to (e.g., in contact with) the ground plane and an upper end coupled to (e.g., in contact with) the patch.

The element being a monolithic and continuous structure implies that any section of the element is continuous with any other section of the element, without an interface (such as a seam) therebetween. Thus, the element is a single integral element that has been additively manufactured.

In an example, the first and second structures support the patch above the ground plane. Note that at this point, the dielectric material between the patch and the ground plane has not been applied yet, and hence, the patch is physically supported above the ground plane by the first and second structures.

In an example, the first structure may be sufficient to support the patch above the ground plane, and hence, in such an example, the second structures may be absent (e.g., see FIG. 7A2). In another example, the first and second structures may, in combination, support the patch above the ground plane (e.g., see FIG. 7A1). Thus, the one or more second structures may be present within the element, or may be absent from the element.

Subsequently, the dielectric material is applied between the ground plane and the patch (e.g., see FIGS. 7B1 and 7B2). In one embodiment, the dielectric material is an appropriate type of dielectric foam. The dielectric foam may be provided within the antenna structure using any appropriate foaming technique, as described below in further detail.

In an example, now the dielectric material at least in part structurally supports the patch above the ground plane, e.g., in addition to the first and second support structures. Thus, the dielectric material can now support the patch above the ground plane. Accordingly, at this stage, the first and second structures may be at least in part removed.

Subsequently, at least a section of the ground plane around the lower end of the first structure is removed, such that the first structure is no longer in contact with the ground plane. In an example, the first structure forms the above described probe to the patch. Furthermore, at least other sections of the ground plane around the lower end of each the second structures are removed, and/or at least a part of each of the second structures are removed, e.g., as illustrated in FIGS. 7C1 and 7C2. For example, FIG. 7C1 illustrates full removal of the second structures, while FIG. 7C2 illustrates partial removal of the second structures. In an example, the removal process can be performed from the bottom of the element, e.g., from the side of the ground plane.

In an example, removal of at least a section of the ground plane around the lower end of the first structure results in a void or opening around the lower end of the first structure, which is the probe. Accordingly, the first structure is no longer physically or electrically coupled to (e.g., in contact with) the ground plane. Also, the upper end of the structure is continuous with, or otherwise in contact with, the patch.

In an example, at least a section of the ground plane around the lower end of the second structures, and/or at least portions of the second structures are also removed from the element. Accordingly, the ground plane is no longer in physical and electrical contact with the second structures, and hence, no longer in physical and electrical contact with the patch through the second structures.

Furthermore, removal at least a section of the ground plane around the lower end of the second structures and/or at least a portion of the second structures result in formation of corresponding voids. In an example, the voids formed by the various removal processes are filled at least in part by dielectric material and/or conductive material, as described below in further detail. Subsequently, an inner conductor of a coaxial cable connector is connected to the lower end of the first structure, and an outer portion of the coaxial cable connector is connected to the ground plane, thereby forming the antenna structure described herein.

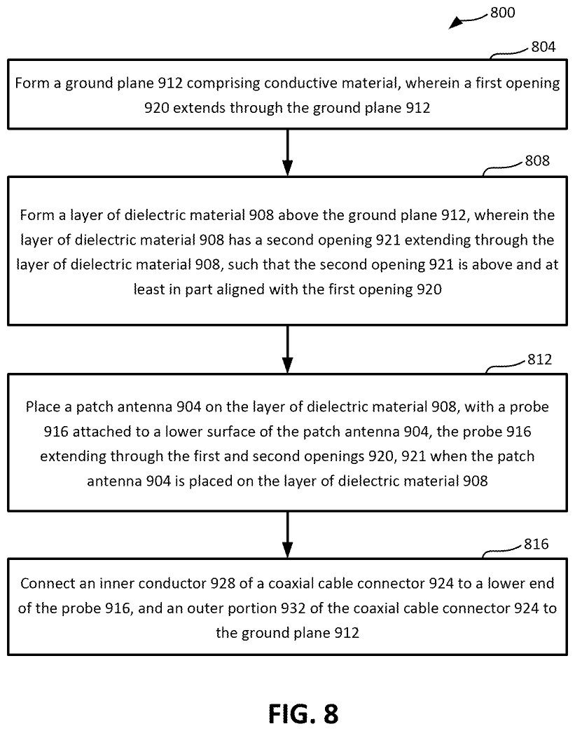

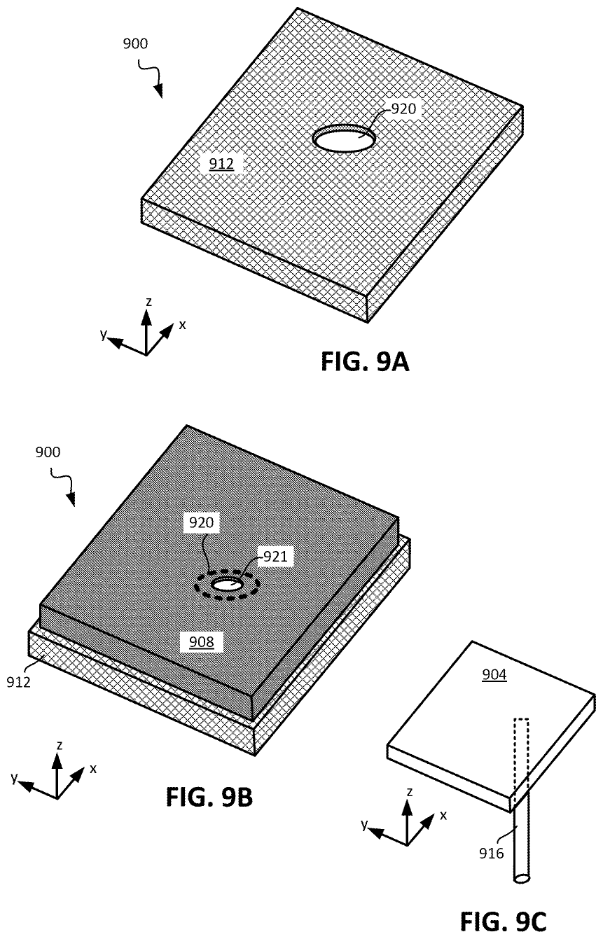

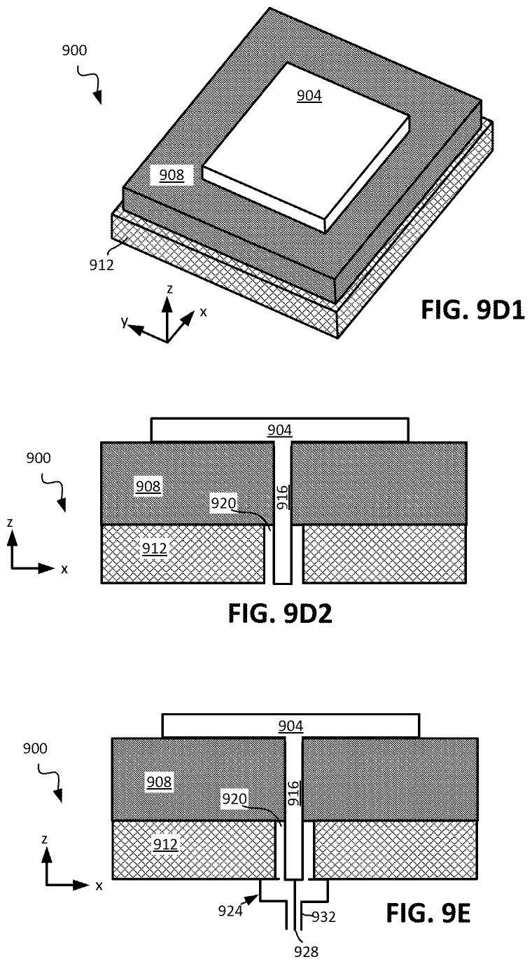

In another approach (e.g., described with respect to FIGS. 8-9E) to manufacture the antenna structure, a ground plane comprising conductive material is formed (e.g., see FIG. 9A). In an example, the ground plane has a first opening therewithin. In an example, the ground plane may be formed using an additive manufacturing process, such as a 3D printing process described above. In such an example, the first opening may be formed within the ground plane, e.g., when forming the ground plane (e.g., conductive material would not be deposited during the 3D printing process within a section, to form the first opening). In another example, the ground plane may be formed without the first opening, and the first opening may be later formed using a subtractive process within the ground plane, e.g., through an appropriate machining or another conductive material removal operation.

Subsequently, a layer of dielectric material is formed above the ground plane (e.g., see FIG. 9B). In an example, the layer of dielectric material has a second opening extending through the layer of dielectric material, such that the second opening is above and at least in part aligned with the first opening. In one embodiment, the dielectric material is an appropriate type of foam. The dielectric foam may be provided using any appropriate foaming technique, some of which is described below in detail. After the dielectric material is deposited, the second opening may be formed, e.g., by machining and forming the second opening from above the dielectric material using a subtractive process.

Then a patch is placed (e.g., attached using an adhesive) on the layer of dielectric material, with a probe attached to a lower surface of the patch (e.g., see FIGS. 9D1 and 9D2). The patch, with the probe attached thereto, may be manufactured using an additive 3D printing process, in an example. In another example, another appropriate process may be employed to form these components. The probe extends within and through the first and second openings, when the patch is placed on the layer of dielectric material.

Subsequently, an inner conductor of a coaxial cable connector is connected to a lower end of the probe, and an outer portion of the coaxial cable connector is connected to the ground plane (e.g., see FIG. 9E), thereby forming the antenna structure described herein. Numerous configurations and variations will be apparent in light of this disclosure.

Materials that are “compositionally different” or “compositionally distinct” as used herein refers to two materials that have different chemical compositions. This compositional difference may be, for instance, by virtue of an element that is in one material but not the other (e.g., copper is compositionally different than an alloy of copper), or by way of one material having all the same elements as a second material but at least one of those elements is intentionally provided at a different concentration in one material relative to the other material (e.g., two copper alloys each having copper and tin, but with different percentages of copper, are also compositionally different). If two materials are elementally different, then one of the materials has an element that is not in the other material (e.g., pure copper is elementally different than an alloy of copper; and two copper alloys each having copper and tin, but with different percentages of copper, are elementally the same).

It should be readily understood that the meaning of “above” and “over” in the present disclosure should be interpreted in the broadest manner such that “above” and “over” not only mean “directly on” something but also include the meaning of over something with an intermediate feature or a layer therebetween. As will be appreciated, the use of terms like “above” “below” “beneath” “upper” “lower” “top” and “bottom” are used to facilitate discussion and are not intended to implicate a rigid structure or fixed orientation; rather such terms merely indicate spatial relationships when the structure is in a given orientation.

### Architecture

FIG. 1A illustrates an exploded view, FIG. 1B illustrates a cross-sectional view, and FIG. 1C illustrates a perspective view of an antenna structure 100, wherein the antenna structure 100 comprises (i) a ground plane 112 comprising conductive material, (ii) a patch 104 above the ground plane 112, (iii) a dielectric material 108 between the ground plane 112 and the patch 104, and (iv) a probe 116 extending through an opening 120 within the ground plane 112 and through the dielectric material 108, the probe 116 between a coaxial connector 124 and the patch 104, in accordance with an embodiment of the present disclosure.

Referring to FIGS. 1A-1C, the dielectric material 108 is arranged as a layer above the ground plane 112. In an example, the dielectric material 108 is an appropriate type of dielectric foam material, although other dielectric materials may also be used, such as an appropriate printed circuit board (PCB) material, FR-4, a composite material comprising woven fiberglass cloth and an epoxy resin binder, glass and/or ceramic material, composite laminate, epoxy, resin, and/or another appropriate dielectric composite material. In an example, the dielectric material 108 may be an additive dielectric material, such as a dielectric foam, epoxy, and/or ceramic powder. The dielectric material 108 can have any appropriate thickness (e.g., in the z-axis direction), such as in the range of 10λ (where λ is the wavelength) to 80λ, although another thickness range may also be possible.

The structure 100 comprises the patch 104 on the dielectric material 108. In one embodiment, the patch 104 comprises a conductive material, such as one or more metals (e.g., copper, gold, silver, aluminum) and/or alloys thereof, or a non-conductive material at least partially plated with a conductive material (e.g., a metal plating). As illustrated in FIGS. 1A-1C, in an example, the patch 104 is in the shape of a square, although another shape may also be possible, such as a circle or a rhombus. In an example, the patch 104 may be attached to an upper surface of the dielectric material 108 using, for example, an adhesive layer (not illustrated in FIGS. 1A-1B).

Although the patch 104 is illustrated above the dielectric material 108, in an example, the patch 104 may be at least in part embedded within the dielectric material 108. For example, in FIG. 7B2 described below, an upper surface of the patch and an upper surface of the dielectric material are coplanar or flush.

The ground plane 112 comprises material that is at least partially electrically conductive (e.g., comprises one or more metals and/or alloys thereof). In some other examples, the material of the ground plane 112 is at least partially non-conductive and at least partially plated with another conductive material (e.g., a metal plating). In an example, the ground plane 112 comprises a metal such as copper or another appropriate metal, and/or an alloy thereof. In an example, the ground plane 112 and the patch 104 may be elementally and/or compositionally same (or different).

In one embodiment, the ground plane 112 includes a hole or opening 120 that extends from an upper surface of the ground plane 112 to a lower surface of the ground plane 112. The probe 116 extends through opening 120 within the ground plane 112, e.g., without making physical and electrical contact with the ground plane 112. Thus, for example, a diameter of the opening 120 is greater than a diameter of the probe 116.

Note that in the perspective view of FIG. 1C, the probe 116 and the opening 120 within the ground plane 112 are not visible, for being covered by the patch 104 and the dielectric material 108.

The probe 116 extends through an opening 121 of the dielectric material 108, as illustrate in FIGS. 1A and 1B. The probe 116 may or may not contact the dielectric material 108, as the probe 116 extends through the dielectric material 108.

In one example, the probe 116 comprises conductive material, such as one or more metals and/or alloys thereof. In another example, the probe 116 comprises non-conductive material, coated by conductive material (e.g., metal coated dielectric material). In an example, the ground plane 112, the patch 104, and/or the probe 116 may be elementally and/or compositionally same (or different).

An upper end of the probe 116 is in physical and electrical contact with the patch 104. For example, the probe 116 ends at the patch 104. In an example and as will be described below, the probe 116 and the patch 104 may be manufactured using an additive manufacturing process, such as a 3D printing process. For example, the probe 116 and the patch 104 may be manufactured using a same material deposition process, and the probe 116 and the patch 104 may comprise elementally and/or compositionally the same material. In such an example, there may not be an interface (such as a seam) between the probe 116 and the patch 104. For example, the probe 116 and the patch 104 may comprise a continuous and monolithic body of conductive material, such as a metal and/or an alloy thereof, without an interface therebetween.

However, in another example, the patch 104 and the probe 116 may be formed using different formation processes, resulting in an interface between the patch 104 and the probe 116.

A lower end of the probe 116 is connected to a coaxial cable connector 124. In FIGS. 1A-1C, the connector 124 is illustrated schematically. The coaxial cable connector 124, for example, may be an appropriate type of coaxial cable connector, such as a SubMiniature Version A (SMA) Connector, a Sub-Miniature Push-on Micro (SMPM) connector, a Gilbert Precision Push-On (GPPO) connector, or another appropriate type of coaxial cable connector. The connector 124 is electrically coupled between the probe 116 and a coaxial cable (not illustrated in FIGS. 1A-1C).

The connector 124 comprises an inner conductor 128 surrounded by a concentric outer conducting shield 132. As illustrated in FIG. 1B, the inner conductor 128 is electrically coupled to (e.g., in direct or indirect physical contact with) the probe 116, and the outer conducting shield 132 is electrically coupled to (e.g., in direct or indirect physical contact with) the ground plane 112. In an example, the inner conductor 128 is separate, and electrically isolated from the outer conducting shield 132 by a dielectric material of the coaxial cable connector 124 (the dielectric material is not labelled in FIGS. 1A-1C).

In an example, the outer conducting shield 132 is electrically grounded, e.g., thereby electrically grounding the ground plane 112. The inner conductor 128 receives an electrical signal, which is transmitted to the patch 104, e.g., via the probe 116. Thus, the probe 116 acts as a feed line to the patch 104. The patch 104 radiates microwave signals, due to fringing fields along the radiating edges of the antenna structure 100.

FIGS. 1B1 and 1C1 illustrate various views of an antenna structure 100b that is at least in part similar to the antenna structure 100 of FIGS. 1A-1C, and wherein the antenna structure 100b of FIGS. 1B1 and 1C1 includes (i) a first section 104a and a second section 104c of the patch 104 having an interface 119 (such as a seam) therebetween, in accordance with an embodiment of the present disclosure.

For example, the patch 104 includes two openings within a section 104c of the patch 104, where the openings are filled with conductive material, to form the sections 104a and 104b of the patch 104. An interface 119 is between the sections 104a and 104c, and another interface is between the sections 104b and 104c. In an example, the conductive material of the sections 104a, 104b and the conductive material of the section 104c are compositionally and/or elementally the same (or may be different). Formation of the sections 104a, 104b, 104c will be described in detail below, with respect to FIG. 7D1.

Similarly, the ground plane 112 includes two openings within a section 112c of the ground plane 112, where the openings are filled with conductive material, to form sections 112a and 112b of the ground plane 112. An interface 121 is between the sections 112b and 112c, and another interface is between the sections 112a and 112c of the ground plane 112. In an example, the conductive material of the sections 112a, 112b and the conductive material of the section 112c are compositionally and/or elementally the same (or may be different). Formation of these sections of the ground plane 112 will also be described in detail below, with respect to FIG. 7D1. Note that the sections of the ground plane 112 are visible in the cross-sectional view of FIG. 1B1, and are not visible in the perspective view of FIG. 1C1.

FIGS. 1B2 and 1C2 illustrate various views of an antenna structure 100c that is at least in part similar to the antenna structure 100 of FIGS. 1A-1C, and wherein the antenna structure 100c of FIGS. 1B1 and 1C1 includes the patch 104 having two openings 104m and 104n that are filled with dielectric material, in accordance with an embodiment of the present disclosure.

For example, the patch 104 includes two (or more, or less) openings 104m and 104n extending from an upper surface of the patch 104 to a lower surface of the patch 104. The openings 104m and 104n are filled with dielectric material, which may be compositionally and/or elementally same or different from the dielectric material 108. Formation of the openings 104m, 104n with the dielectric material will be described in detail below, with respect to FIG. 7D2.

Similarly, the ground plane 112 includes two (or more, or less) openings 112m, 112n within the ground plane 112, where the openings are filled with dielectric material, which may be compositionally and/or elementally same or different from the dielectric material 108. Formation of these openings of the ground plane 112 will also be described in detail below, with respect to FIG. 7D2. Note that the openings of the ground plane 112 are visible in the cross-sectional view of FIG. 1B2, and are not visible in the perspective view of FIG. 1C2.

Referring again to FIGS. 1A-1C, the antenna structure 100 includes a single patch 104. However, in another example, an antenna structure may include a vertical stack of two or more patches. For example, FIG. 2 illustrates a cross-sectional view of an antenna structure 200 that is at least in part similar to the antenna structure 100 of FIGS. 1A-1C2, wherein the antenna structure 200 of FIG. 2 includes a vertical stack of two patches 104 and 204, in accordance with an embodiment of the present disclosure.

Similar components in the antenna structures 100 and 200 are labelled using similar labels. For example, similar to the antenna structure 100 of FIGS. 1A-1C, the antenna structure 200 of FIG. 2 includes the patch 104 above the ground plane 112, and separated from the ground plane 112 by the dielectric material 108. As described above, in some examples, the dielectric material 108 may be dielectric foam, although other types of dielectric material may also be used.

The antenna structure 200 further includes another patch 204 above the patch 104, where the patches 104 and 204 are separated by dielectric material 208. For example, the dielectric material 208 is above the dielectric material 108 and the patch 104, and the patch 204 may be above the dielectric material 208. In one embodiment, the dielectric material 108 may be in contact with the dielectric material 208, and the dielectric materials 108 and 208 may be compositionally and/or elementally the same. In an example, the dielectric materials 108 and 208 may be merged to form a single and continuous layer of dielectric material, with the patch 104 embedded within such a layer of dielectric material.

In some examples, the dielectric material 208 may be dielectric foam, although other types of dielectric material may also be used, such as an appropriate printed circuit board (PCB) material, FR-4, a composite material comprising woven fiberglass cloth and an epoxy resin binder, glass and/or ceramic material, composite laminate, epoxy, resin, and/or another appropriate dielectric composite material.

The probe 116 may extend through the patch 104, and to the patch 204. Thus, in an example, the probe 116 electrically couples the inner conductor 128 of the connector 124 to both the patches 104 and 204.

In an example and as will be described below, the probe 116 and the patches 104 and 204 may be manufactured using an additive manufacturing process, such as a 3D printing process. For example, the probe 116 and the patches 104 and 204 may be manufactured using a same material deposition process, and the probe 116 and the patches 104, 204 may comprise elementally and/or compositionally the same material. In such an example, there may not be an interface (e.g., a seam) between the probe 116 and the patches 104, 204. For example, the probe 116 and the patches 104, 204 may comprise a continuous and monolithic body of conductive material, such as one or more metal and/or an alloy thereof, and may be compositionally and/or elementally the same.

However, in another example, the patch 104, the patch 204, and/or the probe 116 may be formed using different formation processes. For example, this may result in an interface between the patch 104 and the probe 116, and/or between the patch 204 and the probe 116.

In the example of FIGS. 1A-1C and 2, a single probe 116 corresponding to a single polarization (e.g., a vertical polarization or a horizontal polarization) is included in the antenna structures 100 and 200. However, there may be more than one probe, such as two probes corresponding to two polarizations, e.g., a vertical polarization and a horizontal polarization. FIG. 3 illustrates a cross-sectional view of an antenna structure 300 that is at least in part similar to the antenna structure 200 of FIG. 2, wherein the antenna structure 300 of FIG. 3 includes a first probe 116 and a second probe 316, in accordance with an embodiment of the present disclosure.

The probe 316 may be structurally and/or compositionally similar to the probe 116 described above, and will be apparent based on the description of the probe 116. As illustrated, the probe 316 electrically couples the patches 204 and 104 to a connector 324 comprising an inner conductor 328 surrounded by a concentric outer conducting shield 332. The connector 324 may be structurally similar to the connector 124 described above, and will be apparent based on the description of the connector 124. In an example, one of the probes 116, 316 may be used for one of horizontal or vertical polarization signals, and the other of the probes 116, 316 may be used for the other of the horizontal or the vertical polarization signals. The antenna structure 300 will be apparent, based on the description of the antenna structures 100 and 200 of FIGS. 1A, 1B, 1C, and 2.

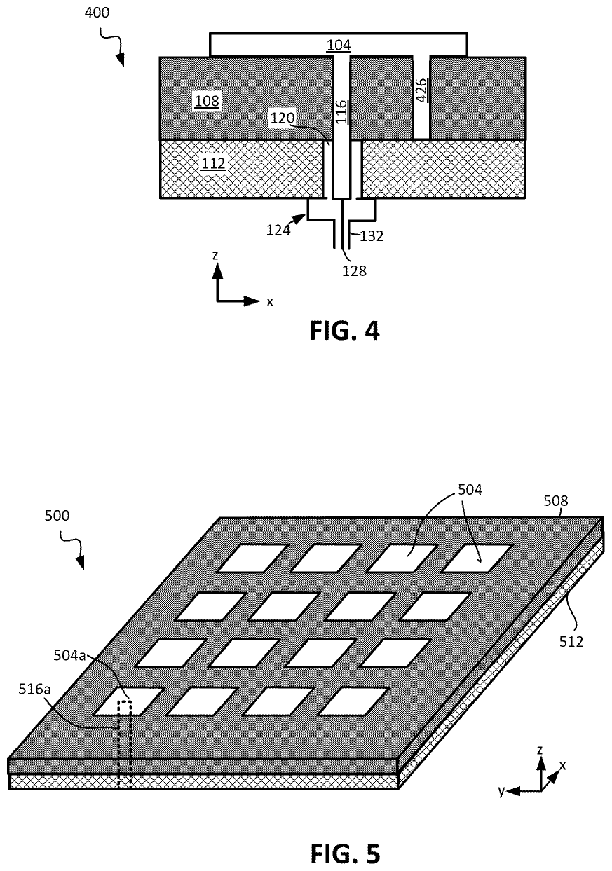

FIG. 4 illustrates a cross-sectional view of an antenna structure 400 that is at least in part similar to the antenna structure 100 of FIGS. 1A-1C2, wherein the antenna structure 400 of FIG. 4 includes a shorting structure 426 that electrically shorts the patch 104 and the ground plane 112, in accordance with an embodiment of the present disclosure. In an example, the shorting structure 426 comprises conductive material, e.g., similar to the conductive material of the ground plane 112 and/or the probe 116. In an example, the conductive shorting structure 426 affects, such as improves, bandwidth of the antenna structure 400. In an example, the shorting structure 426 may also be present between the ground plane 112 and the patch 104 of any of FIGS. 2 and 3 as well.

In an example and as will be described below, the probe 116, the patch 104, the shorting structure 426, and the ground plane 112 may be manufactured using an additive manufacturing process, such as a 3D printing process. For example, the ground plane 112, the shorting structure 426, and the patch 104 may be manufactured using a same material deposition process. In an example, the ground plane 112, the shorting structure 426, and the patch 104 may comprise elementally and/or compositionally the same material. In such an example, there may not be an interface or seam between the shorting structure 426 and the patch 104, and/or between the shorting structure 426 and the ground plane 112. For example, the ground plane 112, the shorting structure 426, the patch 104, and the probe 116 may comprise a continuous and monolithic body of conductive material, such as a metal and/or an alloy thereof.

FIG. 5 illustrates a perspective view of an antenna array 500 comprising a plurality of antenna structures of any of FIGS. 1A-4, in accordance with an embodiment of the present disclosure. For example, the antenna array 500 includes a ground plane 512 that may be common to the plurality of antenna structures of the antenna array 500, where the ground plane 512 may be similar to the ground plane 112 of FIGS. 1A-5. Similarly, the antenna array 500 includes a layer of dielectric material 508 above the ground plane 512, where the layer of dielectric material 508 may be common to the plurality of antenna structures of the array, and where the dielectric material 508 may be similar to the dielectric material 108 of FIGS. 1A-5

The antenna array 500 further comprises a plurality of patches 504, each of which may be similar to the patch 104 described above with respect to FIGS. 1-4. An example patch of the plurality of patches 504 is labelled specifically as 504a.

Note that only a single layer of patches 504 is illustrated in the example of FIG. 5, e.g., similar to the description of FIGS. 1A-1C and 4. However, in another example, the antenna array 500 may include vertical stacks of patches, e.g., as described with respect to FIGS. 2 and 3.

In one example, each patch 504 may be associated with one probe (e.g., as described with respect to FIGS. 1A-1C). In another example, each patch 504 may be associated with more than one probe, such as two probes, e.g., as described with respect to FIG. 3. In the example of FIG. 5, only a single probe 516a is schematically illustrated, where the probe 516a is coupled to (e.g., in contact with) the patch 504a. Note that in the perspective view of FIG. 5, the probe 516a is behind the patch 504a, the dielectric material 516a, and the ground plane 508, and hence, should not be visible in FIG. 5—accordingly, the probe 516a is illustrated using dotted lines in FIG. 5. The probe 516a may be similar to the probe 116 described above. Note that other patches may also have such corresponding probes, but such probes are not illustrated in FIG. 5 for purposes of illustrative clarity.

In one embodiment, each probe may be connected to a corresponding coaxial connector, such as the coaxial connector 124 described above with respect to FIGS. 1A-1C.

The patch 504a, along with the probe 516a and sections of the dielectric material 508 and the ground plane 512 below the patch 504a, forms an antenna structure, such as the antenna structures described above. The array 500 of FIG. 5 comprises several such antenna structures, as illustrated.

### Method of Manufacturing

FIG. 6 illustrates a flowchart depicting a method 600 of forming the example antenna structures of FIGS. 1A-5 using, in accordance with an embodiment of the present disclosure. FIGS. 7A1, 7A2, 7B1, 7B2, 7C1, 7C2, 7D1, 7D2, 7E1, and 7E2 collectively illustrate an example antenna structure in various stages of processing in accordance with the methodology 600 of FIG. 6, in accordance with an embodiment of the present disclosure. FIGS. 6 and 7A1-7E2 will be discussed in unison.

Note that the method 600 and the accompanying 7A1-7E2 illustrate formation of a single antenna structure. However, the method 600 may be adapted to form an antenna array (such as the antenna array 500 of FIG. 5), by forming a plurality of laterally adjacent antenna structures, as will be apparent based on the description of the method 600.

Also, the method 600 and the accompanying 7A1-7E2 illustrate formation of a single layer of patch. However, the method 600 may be adapted to form an antenna structure having a vertical stack of two or more patches (such as the patches 104 and 204 of FIG. 2), e.g., by forming another layer of patch above the layer of patch described with respect to FIG. 6, as will be apparent based on the description of the method 600.

Referring to the method 600 of FIG. 6, at process 604, an element 710 is additively manufactured, as illustrated in FIGS. 7A1 and 7A2. In an example, the element 710 is a monolithic and continuous structure comprising conductive material, such as a metal and/or an alloy thereof. The element 710 being a monolithic and continuous structure implies that any section of the element 710 is continuous with any other section of the element 710 via one or more intervening components, without an interface (such as a seam) therebetween. Thus, the element 710 is a single integral element that has been additively manufactured.

In an example, the element 710 includes (i) a ground plane 712, (ii) a patch 704 above the ground plane 712, (iii) a first structure 716 having a first lower end coupled to (e.g., in contact with) the ground plane 712 and a first upper end coupled to (e.g., in contact with) the patch 704, and (iv) optionally one or more second structures 713a, 713b, each having a second lower end coupled to (e.g., in contact with) the ground plane 712 and a second upper end coupled to (e.g., in contact with) the patch 704.

Thus, in the example of FIG. 1A1, the one or more second structures 713a, 713b are present, whereas the one or more second structures 713a, 713b are absent in the example of FIG. 7A2.

In an example, the structures 716, 713a, 713b support the patch 704 above the ground plane 712. As illustrated, in an example, the structures 716, 713a, 713b extend orthogonally from the ground plane 712 to the patch 704. Note that at this point, the dielectric material between the patch and the ground plane has not been applied yet, and hence, the patch 704 is physically supported above the ground plane 712 by the structures 716, 713a, 713b, in an example.

In an example, the structure 716 may be sufficient to support the patch 704 above the ground plane 712, and hence, in such an example, the structures 713a, 713b may be absent (e.g., see FIG. 7A2). In another example, the structures 716, 713a, 713b may, in combination, support the patch 704 above the ground plane 712 (e.g., see FIG. 7A1).

Thus, in FIG. 7A1, in addition to the structure 716, two other structures 713a and 713b are illustrated to support the patch 704 above the ground plane 712. However, there may be any different number of such structures 713, such as zero (see FIG. 7A2), one, three, four, or higher number of such structures 713 that may, in addition to the structure 716, support the patch 704 above the ground plane 712.

Remaining description of the method 600 assumes that the structures 713a, 713b are present in the element 710. However, the method 600 may be appropriately modified to suit an example in which the structures 713a, 713b are absent in the element 710, as will be apparent based on the description of the method 600.

In an example, additively manufacturing the element 710 may include using any appropriate additive manufacturing techniques to form the element 710. For example, additively manufacturing the element 710 may include printing the element 710 using a three-dimensional (3D) printer. Additive manufacturing, such as 3D printing, uses computer-aided-design (CAD) software and/or 3D object scanners to direct hardware to deposit material, layer upon layer, in precise geometric shapes. As its name implies, additive manufacturing adds material to create an object. Thus, additive manufacturing involves a computer-controlled process that creates 3D objects, such as the element 710, by depositing materials, usually in layers.

In one embodiment, individual sections of the element 710 (e.g., the ground plane 712, the patch 704, and the structures 713a, 713b, 76) comprise conductive material, such as one or more metals and/or alloys thereof. For example, individual sections of the element 710 may comprise copper. Thus, the additive manufacturing process deposits the conductive material, layer by layer, to additively manufacture the element 710, e.g., using a 3D printing process.

Referring again to the method 600 of FIG. 6, the method 600 proceeds from 604 to 608. At 608, a dielectric material 708 is applied between the ground plane 712 and the patch 704, as illustrated in FIGS. 7B1 and 7B2. In an example, now the dielectric material 708 at least in part structurally supports the patch 704 above the ground plane 712, e.g., in addition to the support structures 713a, 713b, 716.

In FIG. 7B1, the patch 704 extends above the dielectric material 708. In contrast, in FIG. 7B2, an upper surface of the patch 704 and an upper surface of the dielectric material 708 are flush or coplanar (e.g., the patch 704 is at least in part embedded within the dielectric material 708). For example, in FIG. 7B2, after applying the dielectric material 708 to embed the patch 704, the dielectric material 708 may be planarized (e.g., using an appropriate polishing or machining operation), such that the upper surface of the patch 704 and the upper surface of the dielectric material 708 are flush or coplanar, as illustrated in FIG. 7B2.

Subsequent FIGS. 7C1-7E2 assume that the patch 704 extends above the dielectric material 708, as illustrated in FIG. 7B1, although the patch 704 may be at least partially or even fully embedded within the dielectric material 708 (as illustrated in the example of FIG. 7B2).

In one embodiment, the dielectric material 708 is an appropriate type of foam. The dielectric foam 708 may be provided within the antenna structure 700 using any appropriate foaming technique. Merely as an example, during the foaming process, a mixture of an activator and a foaming portion may be deposited in the space between the ground plane 712 and the patch 704 of the element 710, and then the element 710 with the foaming mixture may be cured at an appropriate temperature, such that rigid foam forms from the activator and the foaming portion. In another example, a foaming gel or solution may be applied to the element 710 and then cured, such that rigid foam forms within the element 710. In yet another example, a foaming power (e.g., comprising microspheres including resins or another appropriate material) is applied to the element 710 and then cured at an appropriate temperature, such that the foaming power transforms to the rigid dielectric foam 708. Any appropriate foaming process can be used to form the dielectric foam 708, and the selection of the foaming process and/or the selection of an appropriate type of foam may be implementation specific. Examples of dielectric foam includes syntactic film compatible with epoxy prepregs, ester syntactic foam, cyanate ester syntactic foam, epoxy based foam, and/or another appropriate type of foam.

Thus, after application of the dielectric material 708, the dielectric material 708 can now support the patch 704 above the ground plane 712. Accordingly, at this stage of method 600, the structures 713a, 713b, 716 may be at least in part or in its entirety removed.

Referring again to the method 600 of FIG. 6, the method 600 then proceeds from 608 to 612. At 612, (i) at least a section of the ground plane 712 around the lower end of the first structure 716 is removed, such that the first structure 716 is no longer in contact with the ground plane 716, where the first structure 716 forms a probe to the patch 704; and (ii) at least other sections of the ground plane 712 around the lower end of each the second structures 713a, 713b are removed, and/or at least a part of each of the second structures 713a, 713b are removed, as illustrated in FIGS. 7C1 and 7C2.

FIG. 7C1 illustrates full removal of the structures 713a, 713b, while FIG. 7C2 illustrates partial removal of the structures 713a, 713b. Thus, the structures 713a, 713b can be partially or fully removed, as illustrated in FIGS. 7C1 and 7C2. Subsequent FIGS. 7D1-7E2 assume that the structures 713a, 713b are fully remove, as illustrated in FIG. 7C1; although the structures 713a, 713b may be at least partially removed as described in the example of FIG. 7C2.

Referring to FIGS. 7C1 and 7C2, the removal process can be performed from the bottom of the element 710, e.g., from the side of the ground plane 712. Note that after the removal process, the ground plane 712 is now separate (e.g., physically and electrically isolated) from the probe 716 and from the patch 104. Accordingly, in FIGS. 7C1 and 7C2 and subsequent figures, the ground plane 712 is illustrated in a different shading (e.g., similar to the shading of the ground plane in FIGS. 1A-5), e.g., different from that of FIGS. 7A1-7B2.

As illustrated in FIGS. 7C1 and 7C2, removal of at least a section of the ground plane 712 around the lower end of the structure 716 results in a void or opening 720 around the lower end of the structure 716. Accordingly, the structure 716 is no longer physically or electrically coupled to the ground plane 712. Also, the upper end of the structure 716 is continuous with, or otherwise in contact with, the patch 104. As described above, the structure 716 forms the probe of the antenna structure 700, e.g., similar to the probe 116 described above.

As also illustrated in FIGS. 7C1 and 7C2, at least a section of the ground plane 712 around the lower end of the structures 713a, 713b, and/or at least portions of the structures 713a, 713b are also removed from the element 710. Accordingly, the ground plane 712 is no longer in physical and electrical contact with the structures 713a, 713b, and hence, no longer in physical and electrical contact with the patch 704 through the structures 713a, 713b.

Furthermore, as also illustrated in FIGS. 7C1 and 7C2, removal at least a section of the ground plane 712 around the lower end of the structure 713a and/or at least a portion of the structure 713a results in a void 720a. Similarly, removal at least a section of the ground plane 712 around the lower end of the structure 713b and/or at least a portion of the structure 713b results in a void 720b.

In the example of FIG. 7C1, the voids 720a, 720b extend through the ground plane 712, the dielectric material 708, and the patch 704. In the example of FIG. 7C2, the voids 720a, 720b extend through the ground plane 712, and at least partially through the dielectric material 708.

Referring again to the method 600 of FIG. 6, the method 600 then proceeds from 612 to 616. At 616, the voids formed by the various removal processes 612 are filled at least in part by dielectric material and/or conductive material, as illustrated in FIGS. 7D1 and 7D2. Note that in FIGS. 7D1 and 7D2, it is assumed that the voids 720a, 720b extended through the ground plane 712, the dielectric material 708, and the patch 704 (see FIG. 7C1).

In the example of FIG. 7D1, the voids 720a, 720b are filled partially with conductive material, and partially with dielectric material. For example, portions of the voids 720a, 720b (see FIGS. 7C1, 7C2) extending within the patch 704 are filed with conductive material, to form sections 704a and 704b of the patch 704, as illustrated in FIG. 7D1. For example, sections 704a and 704b of the patch 704 and the remaining section 704c of the patch may be compositionally and/or elementally similar (or different). The sections 704a and 704b have been described above with respect to FIGS. 1B1 and 1C1 (e.g., sections 104a and 104b, respectively, of FIGS. 1B1 and 1C1).

In an example, because the sections 704a, 704b are formed using conductive material deposition process that is different from the conductive material deposition process for forming the section 704c, there may be an interface between the sections 704a and 704c, and/or between the sections 704b and 704c, such as an interface 719 illustrated in FIG. 7D1. Thus, the sections 704a, 704b, and 704c may not form a continuous and monolithic structure.

Also, portions of the voids 720a, 720b extending within the dielectric material 708 are filed with dielectric material 708, as illustrated in FIG. 7D1. For example, the dielectric material 708 may be applied using an appropriate foaming process described above, or another process to deposit dielectric material 708 within the portions of the voids 720a, 720b extending within the dielectric material 708.

Also, portions of the voids 720a, 720b extending within the ground plane 712 may be filed with conductive material, as illustrated in FIG. 7D1, to form sections 712a and 712b of the ground plane 712. For example, sections 712a and 712b of the ground plane 712 and a remaining section 712c of the ground plane 712 may be compositionally and/or elementally similar (or different). The sections 712a and 712b have been described above with respect to FIGS. 1B1 and 1C1.

For reasons described with respect to the sections 704a and 704b of the patch 704, in an example, there may be an interface between the sections 712a and 712c, and/or between the sections 712b and 712c, such as an interface 721 illustrated in FIG. 7D1. Thus, the sections 712a, 712b, and 712c of the ground plane 712 may not form a continuous and monolithic structure.

Referring now to the example of FIG. 7D2, the voids 720a, 720b are filled with dielectric material. For example, the patch 704 now has openings 704m and 704n extending therewithin, where the openings 704m and 704n are filed with dielectric material, as also described above with respect to FIGS. 1B2 and 1C2. The dielectric material within the openings 704m and 704n may be similar to (e.g., compositionally and/or elementally same) the dielectric material 708 in an example, although they may be compositionally and/or elementally different in another example. In an example, the dielectric material within the openings 704m and 704n may be dielectric foam material, which may be applied using an appropriate foaming process described above.

Similarly, the ground plane 712 now has openings 712m and 712n extending therewithin, where the openings 712m and 712n are filed with dielectric material, as also described above with respect to FIGS. 1B2 and 1C2. The dielectric material within the openings 712m and 712n may be similar to (e.g., compositionally and/or elementally same) the dielectric material 708 in an example, although they may be compositionally and/or elementally different in another example. In an example, the dielectric material within the openings 712m and 712n of the ground plane 712 may be dielectric foam material, which may be applied using an appropriate foaming process described above.

Referring again to the method 600 of FIG. 6, the method 600 then proceeds from 616 to 620. At 620, an inner conductor 728 of a coaxial cable connector 724 is connected to the lower end of the first structure 716, and an outer portion 732 of the coaxial cable connector 724 is connected to the ground plane 712, as illustrated in FIGS. 7E1 and 7E2. FIG. 7E1 results from the structure illustrate in FIG. 7D1, and FIG. 7E2 results from the structure illustrate in FIG. 7D2. The coaxial cable connector and components thereof have been described herein above with respect to FIGS. 1A-1C.

Note that the processes in method 600 are shown in a particular order for ease of description. However, one or more of the processes may be performed in a different order or may not be performed at all (and thus be optional), in accordance with some embodiments. Numerous variations on method 600 and the techniques described herein will be apparent in light of this disclosure.

FIG. 8 illustrates a flowchart depicting another method 800 of forming the example antenna structures of FIGS. 1A-5, in accordance with an embodiment of the present disclosure. FIGS. 9A, 9B, 9C, 9D1, 9D2, and 9E collectively illustrate an example antenna structure in various stages of processing in accordance with the methodology 800 of FIG. 8, in accordance with an embodiment of the present disclosure. FIGS. 6 and 9A-9E will be discussed in unison.

Note that the method 800 and the accompanying FIGS. 9A-9E illustrate formation of a single antenna structure. However, the method 800 may be adapted to form an antenna array (such as the antenna array 500 of FIG. 5), by forming a plurality of laterally adjacent antenna structures, as will be apparent based on the description of the method 800.

Also, the method 800 and the accompanying 9A-9E illustrate formation of a single layer of patch. However, the method 800 may be adapted to form an antenna structure having a vertical stack of two or more patches (such as the patches 104 and 204 of FIG. 2), e.g., by forming another layer of patch above the layer of patch described with respect to FIG. 8, as will be apparent based on the description of the method 800.

Referring to the method 800 of FIG. 8, at process 804, a ground plane 912 comprising conductive material is formed, as illustrated in FIG. 9A. In an example, the ground plane 912 has an opening 912 therewithin.

In an example, the ground plane 912 may be formed using an additive manufacturing process, such as a 3D printing process described above. In such an example, the opening 920 may be formed within the ground plane 912, e.g., when forming the ground plane 912 (e.g., conductive material would not be deposited during the 3D printing process within a section, to form the opening 920). In another example, the ground plane 912 may be formed without the opening 920, and the opening 920 may be later formed using a subtractive process within the ground plane 912, e.g., through an appropriate machining or another conductive material removal operation.

The method 800 proceeds from 804 to 808. At 808, a layer of dielectric material 908 is formed above the ground plane 912, as illustrated in FIG. 9B. In an example, the layer of dielectric material 908 has a second opening 921 extending through the layer of dielectric material 908, such that the second opening 921 is above and at least in part aligned with the first opening 920.

In one embodiment, the dielectric material 908 is an appropriate type of foam. The dielectric foam 908 may be provided using any appropriate foaming technique, some of which is described above with respect to FIG. 6. After the dielectric material 908 is deposited, the opening 921 is formed, e.g., by machining and forming the opening 921 from above the dielectric material 921 using a subtractive process.

FIG. 9B illustrates the opening 920 within the ground plane 912 using a dotted line, as the opening 920 would be covered by the dielectric material 908. As illustrated, the opening 921 is above and aligned with the opening 920, such that later in the method 800, a probe can extend vertically through the openings 920 and 921.

In an example, a diameter of the opening 920 within the ground plane 912 may be at least as large as, or greater than, a diameter of the opening 921 within the dielectric material 908. For example, as described above (e.g., with respect to FIGS. 1A-1C), the opening 120 has to be large enough such that the probe extending through the opening 920 doesn't touch the opening 920, and a minimum threshold gap is maintained between sidewalls of the opening 920 and the probe, e.g., to avoid or at least reduce chances of electrical arcing and/or electrical shorting between the probe and the ground plane 912. In contrast, there may not be a need to maintain such a gap between the probe and the dielectric material 908, e.g., when the probe extends through the opening 921. Accordingly, in an example, the diameter of the opening 920 within the ground plane 912 may be at least as large as, or greater than, the diameter of the opening 921 within the dielectric material 908.

In method 800 and FIGS. 9A-9B, the opening 920 is formed in the ground plane 912, e.g., prior to formation of the dielectric material 908 above the ground plane 912. However, in another example (and although not illustrated in FIGS. 8, 9A, and 9B), the opening 920 in the ground plane 912 and the opening 921 in the dielectric material 908 may be formed subsequent to formation of the dielectric material 908. In such an example, the ground plane 912 without the opening 920 may be initially formed, and the dielectric material 908 may then be formed above the ground plane 912. Subsequently (e.g., after formation of the dielectric material 908), the openings 920 and 921 may be machined or otherwise formed in the ground plane 912 and the dielectric material 908, respectively, using a subtractive material removal process.

The method 800 proceeds from 808 to 812. At 812, a patch 904 is placed (e.g., attached using an adhesive) on the layer of dielectric material 908, with a probe 916 attached to a lower surface of the patch 904, as illustrated in the perspective view of FIG. 9D1 and the cross-sectional view of FIG. 9D2. The patch 904, with the probe 916 attached thereto, is illustrated in FIG. 9C. The patch 904, with the probe 916 attached thereto, may be manufactured using an additive 3D printing process, in an example. In another example, another appropriate process may be employed to form these components.

As illustrated in FIGS. 9D1 and 9D2, the probe 916 extends within and through the first and second openings 920, 921 when the patch 904 is placed on the layer of dielectric material 908. As described above, the probe 916 extends through the opening 920, without making contact with the ground plane 912, and maintaining a minimum threshold gap between the probe 916 and the ground plane 912 (e.g., to prevent or at least reduce chances of electrical shorting between the probe 916 and the ground plane 912).

The method 800 proceeds from 812 to 816. At 816, an inner conductor 928 of a coaxial cable connector 924 is connected to a lower end of the probe 916, and an outer portion 932 of the coaxial cable connector 924 is connected to the ground plane 912, as illustrated in FIG. 9E. The coaxial cable connector and components thereof have been described herein above with respect to FIGS. 1A-1C.

Note that the processes in method 800 are shown in a particular order for ease of description. However, one or more of the processes may be performed in a different order or may not be performed at all (and thus be optional), in accordance with some embodiments. Numerous variations on method 800 and the techniques described herein will be apparent in light of this disclosure.

### Further Example Examples

The following examples pertain to further examples, from which numerous permutations and configurations will be apparent.

Example 1. A method of manufacturing an antenna assembly, the method comprising: additively manufacturing an element that includes (i) a ground plane, (ii) a patch above the ground plane, and (iii) a structure having a first end in contact with the ground plane and a second end in contact with the patch; applying a dielectric material between the ground plane and the patch; and removing at least a section of the ground plane around the first end of the structure, such that the structure extends through the ground plane and is not in contact with the ground plane.

Example 2. The method of example 1, wherein applying the dielectric material between the ground plane and the patch comprises: providing an additive dielectric material between the ground plane and the patch, the dielectric material at least in part supporting the patch above the ground plane.

Example 3. The method of any one of examples 1-2, wherein dielectric material comprises one or more of a dielectric foam, epoxy, and ceramic powder.

Example 4. The method of any one of examples 1-3, wherein additively manufacturing the element comprises printing the element using a three-dimensional (3D) printer, and wherein the element is monolithic.

Example 5. The method of any one of examples 1-4, further comprising: connecting an inner conductor of a coaxial cable connector to the first end of the structure, and an outer portion of the coaxial cable connector to the ground plane.

Example 6. The method of any one of examples 1-5, wherein: the structure is a first structure; the element further comprises a second structure having a corresponding first end in contact with the ground plane and a corresponding second end in contact with the patch; and the method further comprises removing at least another section of the ground plane around the first end of the second structure, and/or removing at least a part of the second structure.

Example 7. The method of example 6, wherein removing the at least another section of the ground plane around the first end of the second structure results in a void within the ground plane, and wherein the method further comprises one of: filling the void with conductive material; or applying further dielectric material within the void.

Example 8. The method of any one of examples 6-7, wherein: removing at least a part of the second structure results in a void within the dielectric material; and the method further comprises applying further dielectric material within the void.

Example 9. The method of any one of examples 6-8, wherein: removing at least a part of the second structure results in a void within the patch; and the method further comprises one of filling the void with conductive material, or applying further dielectric material within the void.

Example 10. The method of any one of examples 1-9, wherein at least an exterior of the element comprises conductive material.

Example 11. A method of manufacturing an antenna assembly, the method comprising: forming a ground plane comprising conductive material; forming a layer of dielectric material above the ground plane, wherein the ground plane has a first opening extending through the ground plane, and the layer of dielectric material has a second opening extending through the layer of dielectric material, such that the first opening is below and at least in part aligned with the second opening; and placing a patch on the layer of dielectric material, the patch having a probe on a lower surface of the patch, the probe extending within the first and second openings when the patch is placed on the layer of dielectric material.

Example 12. The method of example 11, wherein: forming the ground plane comprises forming the ground plane with the first opening therewithin; and the method further comprises subsequent to forming the layer of dielectric material, forming the second opening within the layer of dielectric material.

Example 13. The method of any one of examples 11-12, further comprising: subsequent to forming the layer of dielectric material, forming the first opening within the ground plane and the second opening within the layer of dielectric material.

Example 14. The method of any one of examples 11-13, wherein forming the ground plane comprises additively manufacturing the ground plane, with the first opening therewithin.

Example 15. The method of any one of examples 11-14, further comprising: connecting an inner conductor of a coaxial cable connector to the probe, and an outer portion of the coaxial cable connector to the ground plane.

Example 16. An antenna structure comprising: a ground plane having a first opening extending from an upper surface of the ground plane to a lower surface of the ground plane; a dielectric material above the ground plane, the dielectric material having a second opening extending from an upper surface of the dielectric material to a lower surface of the dielectric material; a patch above the dielectric material; and a probe comprising conductive material extending from the patch and through the first and second openings, such that the probe extends through the first opening of the ground plane without making a physical contact with the ground plane, wherein the patch and the probe form a monolithic structure.

Example 17. The antenna structure of example 16, wherein: the patch has a third opening therewithin, the third opening comprising dielectric material.

Example 18. The antenna structure of any one of examples 16-17, wherein: the ground plane has a third opening different from the first opening, and wherein the third opening is filled with the dielectric material, without any probe extending through the third opening.

Example 19. The antenna structure of any one of examples 16-18, wherein: the patch comprises (i) a first section, and (ii) a second section around the first section, wherein the first and second sections comprise conductive material, with an interface between the conductive material of the first section and the conductive material of the second section.

Example 20. The antenna structure of any one of examples 16-19, wherein: the ground plane comprises (i) a first section, and (ii) a second section around the first section, wherein the first and second sections comprise conductive material, with an interface between the conductive material of the first section and the conductive material of the second section.

Numerous specific details have been set forth herein to provide a thorough understanding of the examples. It will be understood, however, that other examples may be practiced without these specific details, or otherwise with a different set of details. It will be further appreciated that the specific structural and functional details disclosed herein are representative of examples and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims. Furthermore, examples described herein may include other elements and components not specifically described, such as electrical connections, signal transmitters and receivers, processors, or other suitable components for operation of the antenna system 100.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and examples have been described herein. The features, aspects, and examples are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A method of manufacturing an antenna assembly, the method comprising:
additively manufacturing an element that includes (i) a ground plane, (ii) a patch above the ground plane, and (iii) a structure having a first end in contact with the ground plane and a second end in contact with the patch;
applying a dielectric material between the ground plane and the patch; and
removing at least a section of the ground plane around the first end of the structure, such that the structure extends through the ground plane and is not in contact with the ground plane.

2. The method of claim 1, wherein applying the dielectric material between the ground plane and the patch comprises:
providing an additive dielectric material between the ground plane and the patch, the dielectric material at least in part supporting the patch above the ground plane.

3. The method of claim 1, wherein dielectric material comprises one or more of a dielectric foam, epoxy, and ceramic powder.

4. The method of claim 1, wherein additively manufacturing the element comprises printing the element using a three-dimensional (3D) printer, and wherein the element is monolithic.

5. The method of claim 1, further comprising:
connecting an inner conductor of a coaxial cable connector to the first end of the structure, and an outer portion of the coaxial cable connector to the ground plane.

6. The method of claim 1, wherein:
the structure is a first structure;
the element further comprises a second structure having a corresponding first end in contact with the ground plane and a corresponding second end in contact with the patch; and
the method further comprises removing at least another section of the ground plane around the first end of the second structure, and/or removing at least a part of the second structure.

7. The method of claim 6, wherein removing the at least another section of the ground plane around the first end of the second structure results in a void within the ground plane, and wherein the method further comprises one of:
filling the void with conductive material; or
applying further dielectric material within the void.

8. The method of claim 6, wherein:
removing at least a part of the second structure results in a void within the dielectric material; and
the method further comprises applying further dielectric material within the void.

9. The method of claim 6, wherein:
removing at least a part of the second structure results in a void within the patch; and
the method further comprises one of
filling the void with conductive material, or
applying further dielectric material within the void.

10. The method of claim 1, wherein at least an exterior of the element comprises conductive material.

11. A method of manufacturing an antenna assembly, the method comprising:
forming a ground plane comprising conductive material;
forming a layer of dielectric material above the ground plane, wherein the ground plane has a first opening extending through the ground plane, and the layer of dielectric material has a second opening extending through the layer of dielectric material, such that the first opening is below and at least in part aligned with the second opening; and
placing a patch on the layer of dielectric material, the patch having a probe on a lower surface of the patch, the probe extending within the first and second openings when the patch is placed on the layer of dielectric material.

12. The method of claim 11, wherein:
forming the ground plane comprises forming the ground plane with the first opening therewithin; and
the method further comprises subsequent to forming the layer of dielectric material, forming the second opening within the layer of dielectric material.

13. The method of claim 11, further comprising:
subsequent to forming the layer of dielectric material, forming the first opening within the ground plane and the second opening within the layer of dielectric material.

14. The method of claim 11, wherein forming the ground plane comprises additively manufacturing the ground plane, with the first opening therewithin.

15. The method of claim 11, further comprising:
connecting an inner conductor of a coaxial cable connector to the probe, and an outer portion of the coaxial cable connector to the ground plane.

16. An antenna structure comprising:
a ground plane having a first opening extending from an upper surface of the ground plane to a lower surface of the ground plane;
a dielectric material above the ground plane, the dielectric material having a second opening extending from an upper surface of the dielectric material to a lower surface of the dielectric material;
a patch above the dielectric material; and
a probe comprising conductive material extending from the patch and through the first and second openings, such that the probe extends through the first opening of the ground plane without making a physical contact with the ground plane, wherein the patch and the probe form a monolithic structure.

17. The antenna structure of claim 16, wherein:
the patch has a third opening therewithin, the third opening comprising dielectric material.

18. The antenna structure of claim 16, wherein:
the ground plane has a third opening different from the first opening, and wherein the third opening is filled with the dielectric material, without any probe extending through the third opening.

19. The antenna structure of claim 16, wherein:
the patch comprises (i) a first section, and (ii) a second section around the first section, wherein the first and second sections comprise conductive material, with an interface between the conductive material of the first section and the conductive material of the second section.

20. The antenna structure of claim 16, wherein:
the ground plane comprises (i) a first section, and (ii) a second section around the first section, wherein the first and second sections comprise conductive material, with an interface between the conductive material of the first section and the conductive material of the second section.
